(19) United States
(12) Patent Application Publication
(10) Pub. No.: US 2024/0320812 A1
(43) Pub. Date: Sep. 26, 2024

(54) INFORMATION PROCESSING SYSTEM, INFORMATION PROCESSING METHOD, AND INFORMATION PROCESSING APPARATUS

(71) Applicant: NEC Corporation, Minato-ku, Tokyo (JP)

(72) Inventors: Yoshifumi ONISHI, Tokyo (JP); Koichi Nihei, Tokyo (JP); Takanori Iwai, Tokyo (JP)

(73) Assignee: NEC Corporation, Minato-ku, Tokyo (JP)

(21) Appl. No.: 18/579,961

(22) PCT Filed: Sep. 30, 2021
(86) PCT No.: PCT/JP2021/036288

§ 371 Date: Jan. 17, 2024

(51) Int. Cl. G06T 7/00; H04N 19/167

(52) U.S. Cl. CPC G06T 7/0002; H04N 19/167; G06T 2207/30168

(57) ABSTRACT

An information processing system (1) includes: control means (12) for specifying a time when a change in an image quality of a second video image is set to be equal to or smaller than a threshold based on information about a first video image to be distributed; and transmission means (13) for transmitting information for setting a change in the image quality of the second video image to be equal to or smaller than the threshold at the time specified by the control means and causing the second video image to be distributed.

### TECHNICAL FIELD

The present disclosure relates to an information processing system, an information processing method, and an information processing apparatus.

### BACKGROUND ART

Techniques for estimating a state of a subject based on a video image have been known. With regard to this technique, Patent Literature 1 describes a technique in which an analysis apparatus specifies a part of a person from a video image and estimates his/her pulse rate. Patent Literature 1 also describes detection of motions of a rigid body or non-rigid body as a source of noise, and correction of pulse signals detected from a video image.

### CITATION LIST

### Patent Literature

Patent Literature 1: Published Japanese Translation of PCT International Publication for Patent Application, No. 2021-517843

### SUMMARY OF INVENTION

### Technical Problem

However, Patent Literature 1 does not mention analysis accuracy due to an image quality of a video image. Therefore, in Patent Literature 1, for example, when the image quality of the video image varies, the analysis accuracy may decrease.

In view of the aforementioned problem, an object of the present disclosure is to provide a technology capable of appropriately performing an analysis based on video images distributed via a network.

### Solution to Problem

In a first aspect according to the present disclosure, an information processing system includes: control means for specifying a time when a change in an image quality of a second video image is set to be equal to or smaller than a threshold based on information about a first video image to be distributed; and transmission means for transmitting information for setting a change in the image quality of the second video image to be equal to or smaller than the threshold at the time specified by the control means and causing the second video image to be distributed.

In a second aspect according to the present disclosure, an information processing method includes: processing for specifying a time when a change in an image quality of a second video image is set to be equal to or smaller than a threshold based on information about a first video image to be distributed; and processing for transmitting information for setting a change in the image quality of the second video image to be equal to or smaller than the threshold at the specified time and causing the second video image to be distributed.

In a third aspect according to the present disclosure, an information processing apparatus includes: control means for specifying a time when a change in an image quality of a second video image is set to be equal to or smaller than a threshold based on information about a first video image to be distributed; and transmission means for transmitting information for setting a change in the image quality of the second video image to be equal to or smaller than the threshold at the time specified by the control means and causing the second video image to be distributed.

### Advantageous Effects of Invention

According to one aspect, it is possible to appropriately perform an analysis based on a video image distributed via a network.

### BRIEF DESCRIPTION OF DRAWINGS

FIG. 1 is a diagram showing one example of a configuration of an information processing apparatus according to an example embodiment;

FIG. 2 is a diagram showing one example of a configuration of the information processing apparatus according to the example embodiment;

FIG. 3 is a diagram showing one example of a configuration of an information processing system according to an example embodiment;

FIG. 4 is a diagram showing an example of a hardware configuration of an information processing apparatus according to the example embodiment;

FIG. 5 is a sequence diagram showing one example of processes of the information processing system according to the example embodiment;

FIG. 6 is a diagram showing one example of a specific part DB according to the example embodiment;

FIG. 7 is a diagram showing one example of an area of a specific part according to the example embodiment;

FIG. 8 shows an example of a time length DB 801 according to the example embodiment; and

FIG. 9 is a diagram showing an example of analysis processing based on a video image according to the example embodiment.

### EXAMPLE EMBODIMENT

Principles of the present disclosure are described with reference to several example embodiments. It should be understood that these example embodiments are set forth for purposes of illustration only and that those skilled in the art will assist in understanding and practicing the present disclosure without suggesting limitations on the scope of the present disclosure. The disclosure described herein may be implemented in various methods other than those described below.

In the following description and claims, unless otherwise defined, all technical and scientific terms used herein have the same meaning as commonly understood by one of those skilled in the art of technology to which the present disclosure belongs.

Hereinafter, example embodiments of the present disclosure will be described with reference to the drawings.

### First Example Embodiment

### <Configuration>

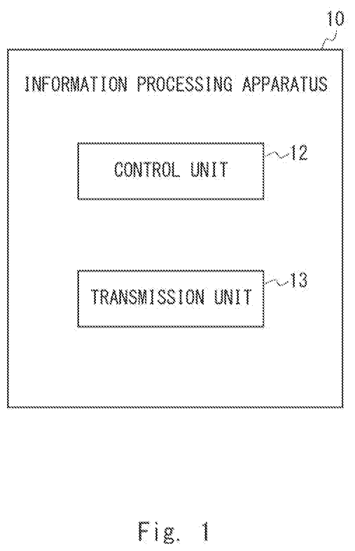

Referring to FIG. 1, a configuration of an information processing apparatus 10 according to an example embodiment will be described. FIG. 1 is a diagram showing one example of the configuration of the information processing apparatus 10 according to the example embodiment. The information processing apparatus 10 includes a control unit 12 and a transmission unit 13. These units may be implemented by cooperation of one or more programs installed in the information processing apparatus 10 and hardware such as a processor 101 and a memory 102 of the information processing apparatus 10.

The control unit 12 specifies (determines) a time (period) when a change in an image quality of a video image is set to be equal to or smaller than a threshold based on information related to a first video image to be distributed. The time may be, for example, a time length (e.g., for 30 seconds) from a specific time point (e.g., present moment) or a period (e.g., from 10:30:30 on Sep. 29, 2021 to 10:31:00 on Sep. 29, 2021). The information about the video image to be distributed may include, for example, at least one of information indicating the image quality of the coded video image and reliability of an analysis based on the coded video image. The control unit 12 receives (acquires) various kinds of information from a storage unit inside the information processing apparatus 10 or from an external apparatus. The control unit 12 executes various kinds of processes based on the video image captured by the image-capturing apparatus 20, coded and distributed. For example, the control unit 12 may execute an analysis (inspection or estimation) based on an area of a specific part of a subject in the video image. For example, a heart rate may be analyzed based on an image of an area of the subject's face. Alternatively, the analysis may be performed by an external apparatus such as a cloud. In this case, the control unit 12 may transmit a video image to the external apparatus and acquire an analysis result obtained by the external apparatus from the external apparatus.

The transmission unit 13 transmits information (command) for setting a change in an image quality of a second video image to be equal to or smaller than a threshold at a time determined by the control unit 12 and causing the second video image to be distributed. Information based on a result of determination by the control unit 12 is transmitted (output) to, for example, each processing unit in the information processing apparatus 10 or the external apparatus. The transmission unit 13 may transmit information (command) for setting a change in an image quality of a specific part of the second video image to be equal to or smaller than a threshold at a time determined by the control unit 12 and causing the second video image to be distributed. The command may include, for example, information indicating an area of a specific part and information indicating a length of time when a change in the image quality is set to be equal to or smaller than the threshold. The information processing apparatus 10 may be an apparatus to which the video image is distributed or an apparatus that distributes the video image.

### <Processes>

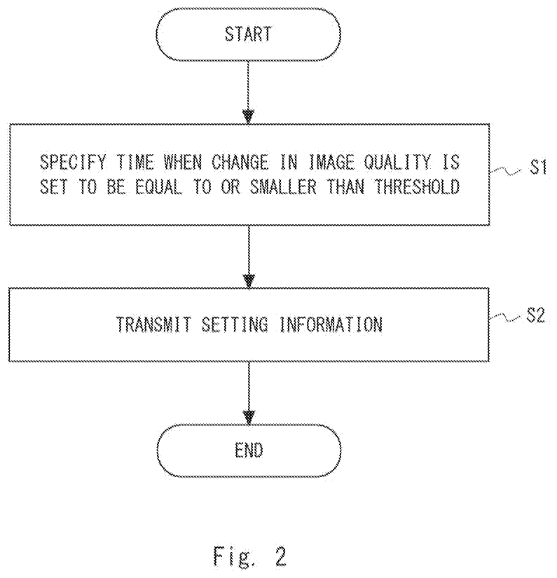

Referring next to FIG. 2, one example of processes in the information processing apparatus 10 according to the example embodiment will be described. FIG. 2 is a flowchart showing one example of the processes in the information processing apparatus 10 according to the example embodiment.

In Step S1, the control unit 12 determines, based on information related to a first video image captured by the image-capturing apparatus 20 and distributed via a network, a time when a change in the image quality of the second video image is set to be equal to or smaller than the threshold. Next, the transmission unit 13 transmits information for setting the change in the image quality of the second video image to be equal to or smaller than the threshold at the time determined by the control unit 12 and causing the second video image to be distributed (Step S2).

(Process Example when Information Processing Apparatus 10 is Apparatus to which Video Image is Distributed)

When the information processing apparatus 10 is an apparatus to which a video image is distributed, the control unit 12 may receive the first video image and the second video image via a network N. Then, the control unit 12 may determine a time when a change in an image quality of an area of a specific part is set to be equal to or smaller than the threshold based on an analysis result of the first video image or the like. Then, the transmission unit 13 may transmit, to the apparatus that distributes the video image, a command for setting the change in the image quality of the second video image distributed from an apparatus that distributes the video image to be equal to or smaller than the threshold at the determined time.

(Process Example when Information Processing Apparatus 10 is Apparatus that Distributes Video Image)

When the information processing apparatus 10 is an apparatus that distributes a video image, the control unit 12 may receive the first video image and the second video image from the image-capturing apparatus 20 built into the information processing apparatus 10 via an internal bus. Further, the control unit 12 may receive the first video image and the second video image from an external (externally attached) image-capturing apparatus 20 connected to the information processing apparatus 10 by a cable or the like via an external bus (e.g., a Universal Serial Bus (USB) cable, a High-Definition Multimedia Interface (HDMI) (registered trademark) cable, or an SDI cable). In this case, the external bus may include, for example, a USB (Universal Serial Bus) cable, an HDMI (High-Definition Multimedia Interface) cable, or an SDI (Serial Digital Interface) cable. The transmission unit 13 may distribute the first and second video images coded by a module or the like that performs coding processing inside the information processing apparatus 10 to the external apparatus. The control unit 12 may acquire the analysis result of the external apparatus from the external apparatus, and determine the time when the change in the image quality of the second video image or the change in the image quality of the area of the specific part in the second video image is set to be equal to or smaller than the threshold based on the analysis result. Then, the transmission unit 13 may transmit, to the module performing coding processing in the information processing apparatus 10, a command for setting a coding parameter of the second video image distributed from the information processing apparatus 10 to be equal to or smaller than the threshold at the determined time.

### <Hardware Configuration>

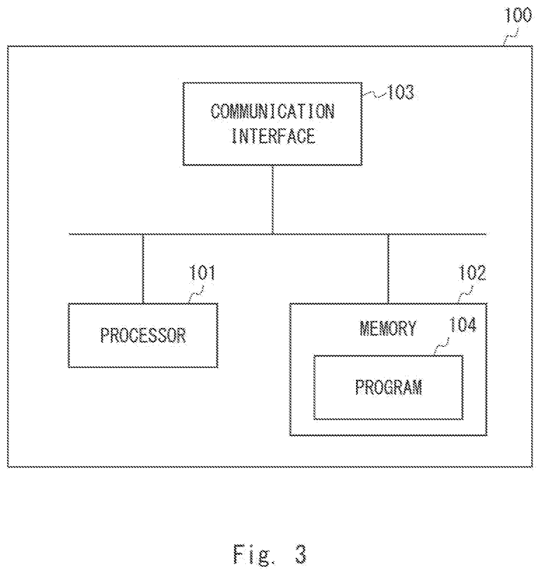

FIG. 3 is a diagram showing an example of a hardware configuration of the information processing apparatus 10 according to the example embodiment. In the example shown in FIG. 3, the information processing apparatus 10 (a computer 100) includes a processor 101, a memory 102, and a communication interface 103. These units may be connected by a bus or the like. The memory 102 stores at least a part of a program 104. The communication interface 103 includes an interface necessary for communication with other network elements.

When the program 104 is executed by cooperation of the processor 101, the memory 102, and the like, the computer 100 performs at least a part of processing for the example embodiment of the present disclosure. The memory 102 may be of any type suitable for a local technical network. The memory 102 may be, by way of non-limiting example, a non-transitory computer readable storage medium. Further, the memory 102 may be implemented using any suitable data storage technology, such as semiconductor based memory devices, magnetic memory devices and systems, optical memory devices and systems, fixed memory and removable memory, as non-limiting examples. While only one memory 102 is shown in the computer 100, there may be several physically distinct memory modules in the computer 100. The processor 101 may be of any type. The processor 101 may include one or more of general purpose computers, special purpose computers, microprocessors, digital signal processors (DSPs) and processors based on multicore processor architecture, as non-limiting examples. The computer 100 may have multiple processors, such as an application specific integrated circuit chip that is slaved in time to a clock which synchronizes the main processor.

The example embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method according to the present disclosure. Generally, program modules include routines, programs, libraries, objects, classes, components, data structures, or the like that perform particular tasks or implement particular abstract data types. The functionality of the program modules may be combined or split between program modules as desired in various example embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus. The program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The program can be stored and provided to a computer using any type of non-transitory computer readable media. Non-transitory computer readable media include any type of tangible storage media. Examples of non-transitory computer readable media include magnetic storage media, optical magnetic storage media, optical disc media, semiconductor memories, etc. The magnetic storage media include, for example, flexible disks, magnetic tapes, hard disk drives, etc. The optical magnetic storage media include, for example, magneto-optical disks. The optical disc media include, for example, a Blu-ray disc, a Compact Disc (CD)-Read Only Memory (ROM), CD-Recordable (R), CD-ReWritable (RW), etc. The semiconductor memories include, for example, solid state drive, mask ROM, Programmable ROM (PROM), Erasable PROM (EPROM), flash ROM, random access memory (RAM), etc. The program(s) may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

### Second Example Embodiment

### <System Configuration>

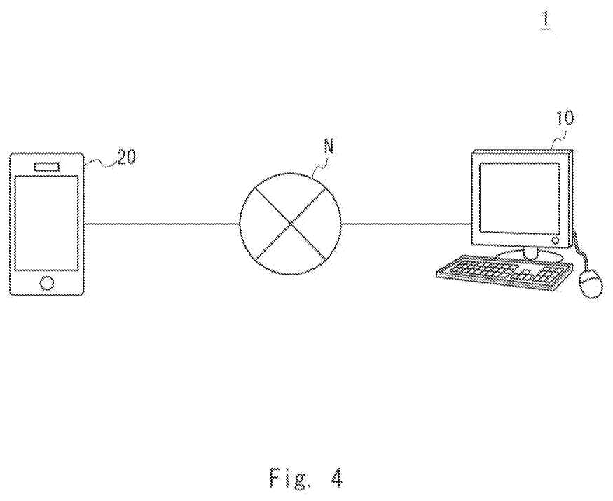

Referring next to FIG. 4, an example of a configuration of an information processing system 1 according to an example embodiment will be described.

FIG. 4 is a diagram showing a configuration example of the information processing system 1 according to the example embodiment. In the example of FIG. 4, the information processing system 1 includes an image-capturing apparatus 20 and an information processing apparatus 10. Note that the number of image-capturing apparatus 20 and the number of information processing apparatus 10 are not limited to those shown in the example in FIG. 4.

Note that the technique according to the present disclosure may be used, for example, for measurement of biological information based on a patient's video image in a video conference (a video call or an online medical examination) between a doctor and a patient (a human being or an animal). The technique according to the present disclosure may also be used, for example, for analysis (specification) of a person and analysis (estimation) of behavior based on video images in a monitoring camera. The technique according to the present disclosure may also be used, for example, for analysis (testing) of a product based on video images of a monitoring camera installed in a factory or a plant.

In the example shown in FIG. 4, the image-capturing apparatus 20 and the information processing apparatus 10 are connected to each other in such a way that they can communicate with each other via a network N. The network N includes, for example, the Internet, a mobile communication system, wireless Local Area Network (LAN), Wi-Fi (registered trademark), LAN, a short-range wireless communication such as Bluetooth (registered trademark) Low Energy (BLE), and the like. The mobile communication system includes, for example, the fifth generation mobile communication system (5G), local 5G, Beyond 5G (6G), the fourth generation mobile communication system (4G), LTE (Long Term Evolution), the third generation mobile communication system (3G), and the like.

The image-capturing apparatus 20 may be, for example, an apparatus including a smartphone, a tablet, a personal computer or the like. The image-capturing apparatus 20 codes a captured video image by any coding scheme and distributes the coded video image to the information processing apparatus 10 via the network N. This coding scheme may include, for example, H.265/High Efficiency Video Coding (HEVC), AOMedia Video 1 (AV1), H.264/MPEG-4 Advanced Video Coding (AVC), and the like.

The information processing apparatus 10 may be, for example, an apparatus such as a personal computer, a server, a cloud, a smartphone, or a tablet. The information processing apparatus 10 may, for example, perform an analysis based on a video image distributed from the image-capturing apparatus 20.

### <Processes>

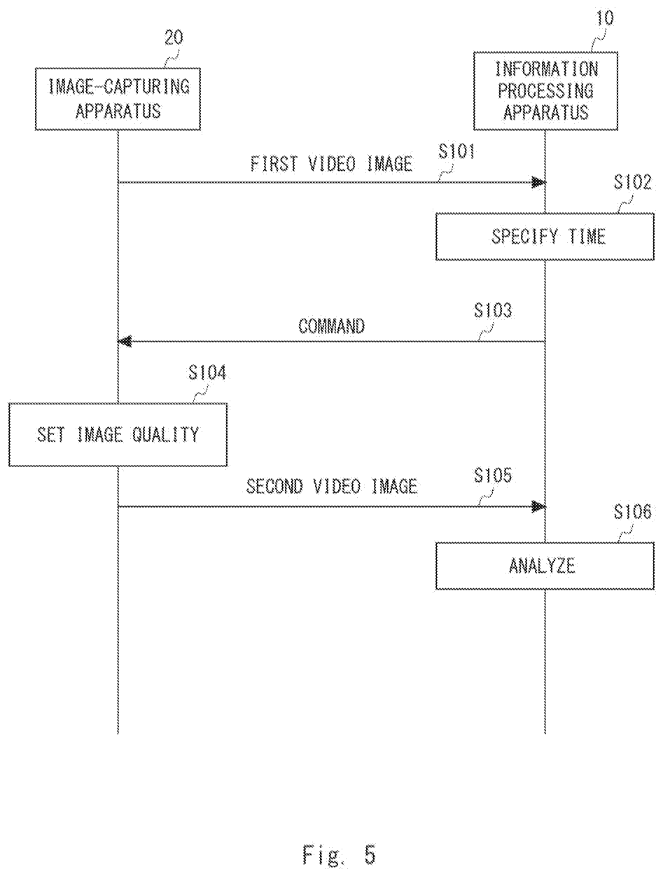

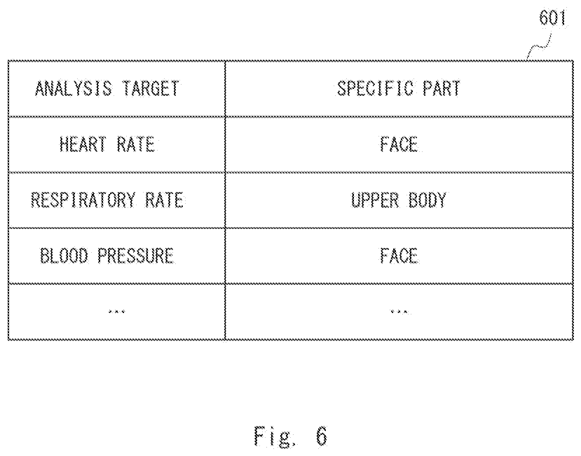

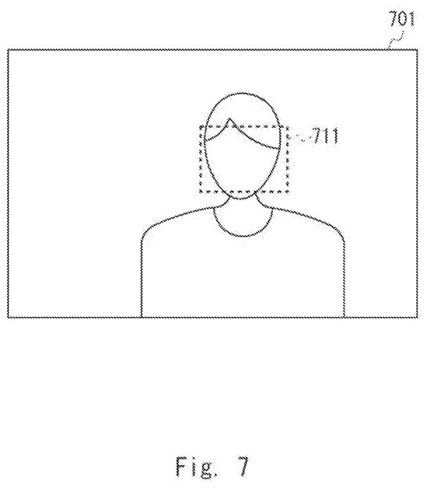

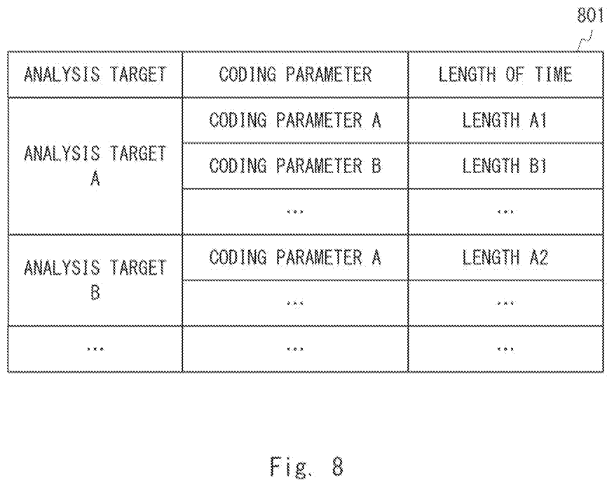

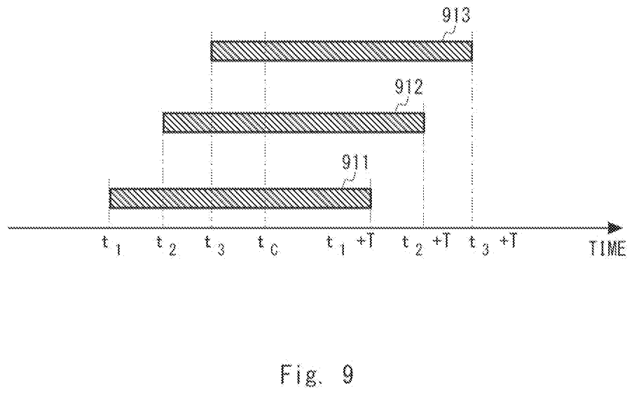

Referring next to FIGS. 5 to 9, one example of processes of the information processing system 1 according to the example embodiment will be described. FIG. 5 is a sequence diagram showing one example of the processes of the information processing system 1 according to the example embodiment. FIG. 6 is a diagram showing one example of a specific part DB (database) 601 according to the example embodiment. FIG. 7 is a diagram showing one example of an area of a specific part according to the example embodiment. FIG. 8 is a diagram showing one example of a time length DB 801 according to the example embodiment. FIG. 9 is a diagram showing one example of analysis processing based on video images according to the example embodiment.

Hereinafter, as one example, a case where biological information based on a patient's video image is measured in a video conference (a video call or an online medical examination) between a doctor and a patient will be described. In the following description, it is assumed that a process of establishing a video conference session or the like between the image-capturing apparatus 20 of the patient and the information processing apparatus 10 of the doctor has already been ended.

In Step S101, the image-capturing apparatus 20 transmits the first video image to the information processing apparatus 10. The first video image obtained by coding an area of a specific part of the subject in the captured image with an image quality higher than that of the area other than the specific part may be distributed (transmitted) to the information processing apparatus 10 via the network N. Here, for example, the image-capturing apparatus 20 may change the image quality of the area of the specific part to code it in accordance with the fluctuation of the bandwidth available in the network N. In this case, the image-capturing apparatus 20 may acquire information indicating the communication quality of the network N at each time point, such as the number of lost packets and jitter, from the information processing apparatus 10 using, for example, RTCP (Real-time Transport Protocol (RTP) Control Protocol). Based on the information indicating the communication quality of the network N at each time point, the image-capturing apparatus 20 may determine the coding parameter such as the bit rate of the area of the specific part at each time point. In this case, for example, the image-capturing apparatus 20 may determine the coding parameter for increasing the image quality of the area of the specific part as the communication quality of the network N becomes higher.

The image-capturing apparatus 20 may, for example, refer to the specific part DB 601 and extract information about the specific part (area of interest) in accordance with an analysis target. An analysis target (item of information about the subject) may include at least one of, for example, heart rate, respiratory rate, blood pressure, swelling, percutaneous arterial oxygen saturation, pupil size, throat swelling, and degree of periodontal disease. The specific part DB 601 may be stored (registered or set) in a storage apparatus inside the image-capturing apparatus 20 or stored in a DB server or the like in the outside of the image-capturing apparatus 20. In the example of FIG. 6, the specific part is recorded in the specific part DB 601 in association with the analysis target. In the example of FIG. 6, for example, when the heart rate is analyzed, it is defined in the specific part DB 601 that a face area should be coded with a high image quality. Note that the analysis target may be designated (selected or set) in advance by a doctor or the like via the information processing apparatus 10. Further, the analysis target may be designated by the information processing apparatus 10 based on a result of a medical questionnaire previously input from a patient on a predetermined website or the like.

The image-capturing apparatus 20 may detect the area of the specific part in the captured video image. Here, the image-capturing apparatus 20 may determine an area including the specific part such as a face in each frame using AI (Artificial Intelligence) or the like based on the image of each frame captured by the image-capturing apparatus 20.

The image-capturing apparatus 20 may code the area of the specific part with an image quality higher than that of the area other than the specific part. The image quality may include, for example, an image quality based on at least one of a bit rate of coding, a frame rate of coding, and a QP value of coding. In this case, the image-capturing apparatus 20 may code each frame of the first video image using, for example, a map (QP map) that sets a quantization parameter (QP value) of coding for each specific pixel area unit (e.g., 16 pixels vertically×16 pixels horizontally). When hierarchical coding (SVC, Scalable Video image Coding) is used as the coding scheme, for example, the image-capturing apparatus 20 may code an area of a specific part with an image quality higher than that of an area other than the specific part by using the entire frame as a base layer and an area of a specific part as an enhancement layer.

Note that the image-capturing apparatus 20 may code the area other than the specific part with an image quality lower than that of the area of the specific part. In this case, the image-capturing apparatus 20 may degrade the image quality of the area of the specific part by, for example, lowering the bit rate of coding, lowering the frame rate, or increasing the QP value. Thus, for example, the bandwidth usage in the network N can be reduced when video images are distributed.

Next, the control unit 12 of the information processing apparatus 10 specifies (determines) a time when the change in the image quality (e.g., coding parameter) of the second video image, which the delivered video image is used for analyzing the information about the subject, is set to be equal to or smaller than the threshold (e.g., is set constant) based on the received information about the first video image (Step S102). Hereinafter, the changes in the image quality being equal to or smaller than the threshold may also be referred to as “substantially constant” as needed. In the present disclosure, “constant” refers to a certain range. The second video image is a video image distributed at a later time than the first video image. The information about the first video image may include, for example, at least one of information indicating the image quality of the first video image (e.g., the coding parameter of the first video image) and the reliability of the analysis based on the first video image.

Here, the control unit 12 of the information processing apparatus 10 may measure (calculate, infer, or estimate) information about various analysis targets of the subject using AI or the like based on the first video image by processing similar to the processing of Step S106 described later. The control unit 12 may determine the time when the coding parameter or the like of the area of the specific part in the second video image is set to remain constant only when the reliability of the analysis result calculated by AI or the like is equal to or smaller than the threshold. This is because, for example, when the reliability of the estimation by AI or the like is equal to or smaller than the threshold, it is considered that the accuracy of the analysis by AI or the like can be improved by reducing the fluctuation of the bit rate or the like of the area used for analysis for a certain time.

Further, the control unit 12 of the information processing apparatus 10 may estimate the reliability of the analysis of the information about the subject based on the received information indicating the image quality of the first video image, and determine the time when the change in the image quality of the area of the specific area in the second video image is set to be equal to or smaller than the threshold only when the estimated reliability is equal to or smaller than the threshold. In this case, for example, the control unit 12 of the information processing apparatus 10 may estimate a value of the reliability higher as the image quality of the area of the specific area at each time point included in the time is higher. For example, the control unit 12 of the information processing apparatus 10 may estimate the value of the reliability lower as the change in the image quality of the area of the specific area at each time point included in the time is larger. This is because, for example, when the bit rate or the like of the area of the specific part is rapidly increased or rapidly decreased, noise is generated in the decoded video image, and the reliability of analysis by AI or the like is considered to be lowered.

In this case, the control unit 12 of the information processing apparatus 10 may calculate an estimated value of the reliability of analysis based on a video image 911 based on, for example, a weighted average obtained by adding the weight of the time length, which is each image quality, to a value corresponding to the image quality at each time point, and a value corresponding to a change in the image quality. For example, suppose that at time t_{c} in FIG. 9, the image quality of an area of a specific part is changed from the first video image quality to the second video image quality due to a change in the coding parameter. In this case, an estimated value E₁ of the reliability of the analysis based on the video image 911 may be calculated as in the following Expression (1).

$${E}_{1} = \{ {Q}_{1} \times ( {t}_{c} - {t}_{1} ) + {Q}_{2} \times ( {t}_{1} + T - {t}_{c} ) \} / T - {Q}_{3} \qquad ( 1 )$$

In Expression (1), a value Q₁ corresponding to the first image quality is weighted by the time length from the time t₁ to time to, and a value Q₂ corresponding to the second image quality is weighted by a time length from the time t_{c} to time t₁+T. A value Q₃ corresponding to a change from the first image quality to the second image quality is subtracted from the weighted average value of Q₁ and Q₂. The value Q₁ corresponding to the first image quality, Q₂ corresponding to the second image quality, and Q₃ corresponding to the change from the first image quality to the second image quality may be preset (registered) in a database or the like or may be calculated by AI or the like.

(Example in which Time Length for Change in Image Quality is Set to be Equal to or Smaller than Threshold is Determined)

The control unit 12 of the information processing apparatus 10 may determine the time length in accordance with at least one of the coding parameter, which is to be made constant at least in the area of the specified part, and the analysis target. Thus, for example, each analysis target can be analyzed with a certain accuracy. In this case, the control unit 12 of the information processing apparatus 10 may determine a shorter time length as the image quality designated by the coding parameter is higher.

The control unit 12 of the information processing apparatus 10 may refer to a time length DB 801, for example, and extract information about the coding parameter and the time length corresponding to the analysis target. Note that the time length DB 801 may be stored (registered or set) in a storage apparatus inside the information processing apparatus 10, or may be stored in a DB server or the like in the outside of the information processing apparatus 10. In the example of FIG. 8, in the time length DB 801, a time length is recorded in association with a pair of the analysis target and the coding parameter. Note that the analysis target may be designated (selected or set) in advance by a doctor or the like through the information processing apparatus 10. Further, the analysis target may be designated by the information processing apparatus 10 based on a result of a medical questionnaire previously input from a patient on a predetermined website or the like.

(Example in which Coding Parameter for Setting Change in Image Quality of Video Image to be Equal to or Smaller than Threshold is Determined)

The control unit 12 of the information processing apparatus 10 may determine a coding parameter for setting a change in an image quality of a video image to be equal to or smaller than a threshold at a specified time from among a plurality of coding parameters of the video image in accordance with an analysis target. By doing so, for example, each analysis target can be appropriately analyzed.

In this case, when the analysis target is a pulse rate, the control unit 12 of the information processing apparatus 10 may make only the frame rate for the area of the specific part substantially constant. This is because when the analysis target is a pulse rate, it is preferable to use a relatively high frame rate of about 20 to 30 fps in order to detect a frequency component of a color change of about 1 Hz in the face area.

In addition, when the analysis target is a respiratory rate, the control unit 12 of the information processing apparatus 10 may make only the resolution for the area of the specific part substantially constant. This is because when the analysis target is a respiratory rate, it is sufficient to detect slow movements of the shoulders and chest associated with breathing, and a frame rate of about 10 fps, which is lower than the frame rate of the video image conference image, may be used.

In this case, the control unit 12 of the information processing apparatus 10 may degrade the image quality of items other than those designated by the information processing apparatus 10 in the area of the specific part (e.g., patient's face). In this way, for example, the communication amount of the second video image can be reduced.

(Example in which Time is Determined Based on Fluctuation of Bandwidth)

The control unit 12 of the information processing apparatus 10 may determine, based on at least one of a measured value and a predicted value of the bandwidth available in the network N through which the video image is distributed, at least one of the time length and a starting point of the time when the change of the image quality of the area of the specific part is set to be equal to or smaller than the threshold. Thus, the time length can be set in accordance with the available bandwidth. When the available bandwidth is equal to or greater than the threshold, it is possible to start the time when the change in an image quality of the area of the specific area is set to be equal to or smaller than the threshold. By making a decision based on the predicted value of the available bandwidth, for example, it is possible to start the time when the change in the image quality of the area of the specific area is set to be equal to or smaller than the threshold while a certain bandwidth can be used.

Note that the control unit 12 of the information processing apparatus 10 may perform machine learning of communication log information when data such as a video image was transmitted via the network N in the past, radio quality information such as a radio wave strength, a day of the week or a time, and a relation between weather and available bandwidth in advance, and calculate available bandwidth or a predicted bandwidth value.

Next, the transmission unit 13 of the information processing apparatus 10 transmits, to the image-capturing apparatus 20, information (command) for setting the change in the image quality of the specific part to be equal to or smaller than the threshold at the time determined by the control unit 12 and causing the video image to be distributed (Step S103). The command may include, for example, information indicating the coding parameter of the specific part and information indicating the time length.

Next, based on the received command, the image-capturing apparatus 20 sets the change in the image quality of the area of the specific part of the subject in the video image captured by the image-capturing apparatus 20 to be equal to or smaller than a specific time threshold (Step S104). Next, the image-capturing apparatus 20 distributes (transmits) the second video image obtained by coding the area of the specific part of the subject in the captured image with a specific image quality to the information processing apparatus 10 via the network N (Step S105). In the example of FIG. 7, an area 711 of a patient's face in a frame 701 included in the second video image is coded with a substantially constant specific image quality at a specific time.

Next, the control unit 12 of the information processing apparatus 10 analyzes the subject based on the area of the specific part of the subject with the specific image quality in the received second video image (Step S106). Here, the control unit 12 of the information processing apparatus 10 may measure (calculate, infer, or estimate) various kinds of information about the subject to be analyzed by AI (Artificial Intelligence) using deep learning or the like.

In this case, the control unit 12 of the information processing apparatus 10 may, for example, extract a plurality of video images of a predetermined time length with different starting points from the second video image, and perform an analysis of biological information or the like based on the plurality of extracted video images using AI or the like. In the example of FIG. 9, the analysis result and the reliability of the analysis result are calculated based on the video image 911 from the time t₁ to the predetermined time length T, a video image 912 from the time t₂ to the predetermined time length T, and a video image 913 from the time t₃ to the predetermined time length T. The control unit 12 of the information processing apparatus 10 may determine a weighted average or the like, which is obtained by adding the weight of the reliability of various analysis results, as a value of the biological information. For example, suppose that the estimated heart rate based on the video image 911 is 83 and the reliability is 0.8, the estimated heart rate based on the video image 912 is 85 and the reliability is 0.7, and the estimated heart rate based on the video image 913 is 90 and the reliability is 0.7. In this case, for example, the heart rate is calculated as (83×0.8+85×0.7+90×0.7)/(0.8+0.7+0.7)=86.

The analysis target may include, for example, at least one of a heart rate, a respiratory rate, blood pressure, swelling, transcutaneous arterial blood oxygen saturation, a pupil size, throat swelling, or a degree of periodontal disease. The control unit 12 of the information processing apparatus 10 may control a display device to display the patient's biological information (vital signs) that is the analysis result.

The control unit 12 of the information processing apparatus 10 may estimate a heart rate based on a video image including an area where the patient's skin is exposed (e.g., face area). In this case, the control unit 12 of the information processing apparatus 10 may estimate the heart rate based on, for example, transition (period) of changes in the skin color.

Further, the control unit 12 of the information processing apparatus 10 may estimate a respiratory rate based on a video image of an area of the patient's chest (upper body). In this case, the control unit 12 of the information processing apparatus 10 may estimate the respiratory rate based on, for example, a cycle of shoulder movements.

Further, the control unit 12 of the information processing apparatus 10 may estimate blood pressure based on the video image of the area where the patient's skin is exposed (e.g., face area). In this case, the control unit 12 of the information processing apparatus 10 may estimate the blood pressure based on, for example, the difference between pulse waves estimated from two parts of the face (e.g., forehead and cheeks) and the shapes of these pulse waves.

Further, the control unit 12 of the information processing apparatus 10 may estimate transcutaneous arterial blood oxygen saturation (SpO2) based on the video image including the area where the patient's skin is exposed (e.g., face area). Note that red is easily transmitted when hemoglobin is bonded to oxygen, while blue is insusceptible to the binding of hemoglobin to oxygen. Therefore, the control unit 12 of the information processing apparatus 10 may estimate SpO2 based on, for example, the difference in the degree of change in the blue color and red color of the skin near the cheekbones under the eyes.

Further, the control unit 12 of the information processing apparatus 10 may estimate, for example, a degree of swelling based on a video image including the patient's eyelid area. Further, the control unit 12 of the information processing apparatus 10 may estimate, for example, a pupil size (pupil diameter) based on a video image of the patient's eye area. Further, the control unit 12 of the information processing apparatus 10 may estimate, for example, throat swelling, a degree of periodontal disease, or the like based on a video image of the patient's mouth area.

<<Example in which Change in Image Quality of Video Image is Set to be Equal to or Smaller than Threshold>>

In the example shown in FIG. 5, an example in which a change in the image quality of the area of the specific part corresponding to the analysis target is set to be equal to or smaller than the threshold has been described. However, the present disclosure is not limited to this example. In the following, an example in which a change in the image quality of each frame is set to be equal to or smaller than a threshold will be described.

In Step S101 of FIG. 5, the image-capturing apparatus 20 may distribute the first video image coded using a known coding scheme to the information processing apparatus 10. Next, in Step S103 of FIG. 5, the transmission unit 13 of the information processing apparatus 10 transmits, to the image-capturing apparatus 20, information (command) for setting the change in the image quality is set to be equal to or smaller than the threshold at the time determined by the control unit 12 and causing the video image to be distributed. The command may include, for example, information indicating the time length. In Step S104 of FIG. 5, the image-capturing apparatus 20 may set the change in the image quality (e.g., bit rate, frame rate) of the captured video image to be equal to or smaller than a certain time threshold based on the received command.

(Example in which Person is Specified by Using Video Image of Image-Capturing Apparatus 20, which is Monitoring Camera)

In the aforementioned example, the example of measuring biological information in a video conference between a doctor and a patient has been described. In the following description, an example in which a person is specified by using a video image of the image-capturing apparatus 20, which is a monitoring camera, will be described. In this case, a video image of the image-capturing apparatus 20 may be distributed from the image-capturing apparatus 20 to the information processing apparatus 10.

First, when the area of the person cannot be detected based on the video image of the image-capturing apparatus 20, the control unit 12 of the information processing apparatus 10 may set the image quality of the entire frame to be substantially constant at a specific time. Further, when the person cannot be specified based on the video image of the image-capturing apparatus 20, the control unit 12 of the information processing apparatus 10 may set the image quality of the area of the specific part such as the face of the person to be substantially constant at a specific time. Further, when person's behavior cannot be specified based on the video image of the image-capturing apparatus 20, the control unit 12 of the information processing apparatus 10 may set the image quality of the area of the whole body of the person to be substantially constant at a specific time.

(Example in which Product is Tested (Inspected) by Video Image of Image-Capturing Apparatus 20)

In the following description, an example in which a product is tested (inspected) by a video image of the image-capturing apparatus 20, which is a monitoring camera, will be described. In this case, a video image of the image-capturing apparatus 20 may be distributed from the image-capturing apparatus 20 to the information processing apparatus 10.

First, when the area of the product cannot be detected based on the video image of the image-capturing apparatus 20, the control unit 12 of the information processing apparatus 10 may set the image quality of the entire frame to be substantially constant at a specific time. Further, when the product cannot be tested based on the video image of the image-capturing apparatus 20, the control unit 12 of the information processing apparatus 10 may set the image quality of the area of the product to be substantially constant at a specific time.

(Example in which Facility is Checked by Using Video Image of Image-Capturing Apparatus 20)

In the following description, an example in which a facility is checked by using a video image of an image-capturing apparatus 20 mounted on a drone, a robot that autonomously moves on the ground, or the like will be described. In this case, a video image of the image-capturing apparatus 20 may be distributed from the image-capturing apparatus 20 mounted on the drone or the like to the information processing apparatus 10.

First, when an area of an object to be checked (e.g., a steel tower, an electric wire, or the like) cannot be detected based on the video image of the image-capturing apparatus 20, the control unit 12 of the information processing apparatus 10 may set the image quality of the entire frame to be substantially constant at a specific time. Further, when a part to be checked (e.g., an insulator) cannot be tested (e.g., measurement of a damage or a degradation level) based on the video image of the image-capturing apparatus 20, the control unit 12 of the information processing apparatus 10 may set the image quality of the area of the specific part including a part to be checked to be substantially constant at a specific time.

### MODIFIED EXAMPLES

While the information processing apparatus 10 may be an apparatus included in one housing, the information processing apparatus 10 according to the present disclosure is not limited to this example. Each unit of the information processing apparatus 10 may be implemented, for example, by cloud computing constituted by one or more computers. Further, at least a part of the processes of the information processing apparatus 10 may be implemented, for example, by another information processing apparatus 10. Such an information processing apparatus 10 is also included in one example of the “information processing apparatus” according to the present disclosure.

Note that the present disclosure is not limited to the aforementioned example embodiments and may be changed as appropriate without departing from the spirit of the present disclosure.

The whole or part of the example embodiments disclosed above can be described as, but not limited to, the following Supplementary notes.

### (Supplementary Note 1)

An information processing system comprising:
control means for specifying a time when a change in an image quality of a second video image is set to be equal to or smaller than a threshold based on information about a first video image to be distributed; and
transmission means for transmitting information for setting a change in the image quality of the second video image to be equal to or smaller than the threshold at the time specified by the control means and causing the second video image to be distributed.

### (Supplementary Note 2)

The information processing system according to supplementary note 1, wherein the control means specifies a length of the time in accordance with an image quality of the first video image.

### (Supplementary Note 3)

The information processing system according to supplementary note 1 or 2, wherein the control means specifies the length of the time in accordance with an analysis target.

### (Supplementary Note 4)

The information processing system according to any one of supplementary notes 1 to 3, wherein the control means specifies a coding parameter set to be constant at the time from among a plurality of coding parameters of the second video image in accordance with the analysis target.

### (Supplementary Note 5)

The information processing system according to any one of supplementary notes 1 to 4, wherein the control means specifies, at the time, the coding parameter for an area of a specific part of a subject used for an analysis to be constant.

### (Supplementary Note 6)

The information processing system according to any one of supplementary notes 1 to 5, wherein the control means specifies at least one of the length of the time and a starting point of the time based on at least one of a measured value and a predicted value of a bandwidth available in a network through which the second video image is distributed.

### (Supplementary Note 7)

The information processing system according to any one of supplementary notes 1 to 6, wherein the image quality of the second video image includes an image quality based on at least one of a bit rate of coding, a frame rate of the coding, a quantization parameter of the coding, and an area of each layer in hierarchical coding.

### (Supplementary Note 8)

An information processing method comprising:
processing for specifying a time when a change in an image quality of a second video image is set to be equal to or smaller than a threshold based on information about a first video image to be distributed; and
processing for transmitting information for setting a change in the image quality of the second video image to be equal to or smaller than the threshold at the specified time and causing the second video image to be distributed.

### (Supplementary Note 9)

The information processing method according to supplementary note 8, wherein, in the specifying processing, a length of the time is specified in accordance with an image quality of the first video image.

### (Supplementary Note 10)

The information processing method according to supplementary note 8 or 9, wherein, in the specifying processing, the length of the time is specified in accordance with an analysis target.

### (Supplementary Note 11)

The information processing method according to any one of supplementary notes 8 to 10, wherein, in the specifying processing, a coding parameter set to be constant at the time is specified from among a plurality of coding parameters of the second video image in accordance with the analysis target.

### (Supplementary Note 12)

The information processing method according to any one of supplementary notes 8 to 11, wherein, in the specifying processing, the coding parameter for an area of a specific part of a subject used for an analysis is specified to be constant.

### (Supplementary Note 13)

The information processing method according to any one of supplementary notes 8 to 12, wherein, in the specifying processing, at least one of the length of the time and a starting point of the time is specified based on at least one of a measured value and a predicted value of a bandwidth available in a network through which the second video image is distributed.

### (Supplementary Note 14)

The information processing method according to any one of supplementary notes 8 to 13, wherein the image quality of the second video image includes an image quality based on at least one of a bit rate of coding, a frame rate of the coding, a quantization parameter of the coding, and an area of each layer in hierarchical coding.

### (Supplementary Note 15)

An information processing apparatus comprising:
control means for specifying a time when a change in an image quality of a second video image is set to be equal to or smaller than a threshold based on information about a first video image to be distributed; and
transmission means for transmitting information for setting a change in the image quality of the second video image to be equal to or smaller than the threshold at the time specified by the control means and causing the second video image to be distributed.

### (Supplementary Note 16)

The information processing apparatus according to supplementary note 15, wherein the control means specifies a length of the time in accordance with an image quality of the first video image.

### (Supplementary Note 17)

The information processing apparatus according to supplementary note 15 or 16, wherein the control means specifies the length of the time in accordance with an analysis target.

### (Supplementary Note 18)

The information processing apparatus according to any one of supplementary notes 15 to 17, wherein the control means determines a coding parameter set to be constant at the time from among a plurality of coding parameters of the second video image in accordance with the analysis target.

### (Supplementary Note 19)

The information processing apparatus according to any one of supplementary notes 15 to 18, wherein the control means specifies, at the time, the coding parameter for an area of a specific part of a subject used for an analysis to be constant.

### (Supplementary Note 20)

The information processing apparatus according to any one of supplementary notes 15 to 19, wherein the control means specifies at least one of the length of the time and a starting point of the time based on at least one of a measured value and a predicted value of a bandwidth available in a network through which the second video image is distributed.

### (Supplementary Note 21)

The information processing apparatus according to any one of supplementary notes 15 to 20, wherein the image quality of the second video image includes an image quality based on at least one of a bit rate of coding, a frame rate of the coding, a quantization parameter of the coding, and an area of each layer in hierarchical coding.

### REFERENCE SIGNS LIST

1 INFORMATION PROCESSING SYSTEM
10 INFORMATION PROCESSING APPARATUS
10A INFORMATION PROCESSING APPARATUS
10B INFORMATION PROCESSING APPARATUS
12 CONTROL UNIT
13 TRANSMISSION UNIT
20 IMAGE-CAPTURING APPARATUS
N NETWORK

What is claimed is:

1. An information processing system comprising:
at least one memory storing instructions, and
at least one processor configured to execute the instructions to;
specify a time when a change in an image quality of a second video image is set to be equal to or smaller than a threshold based on information about a first video image to be distributed; and
transmit information for setting a change in the image quality of the second video image to be equal to or smaller than the threshold at the specified time and causing the second video image to be distributed.

2. The information processing system according to claim 1, wherein the at least one processor is configured to specify a length of the time in accordance with an image quality of the first video image.

3. The information processing system according to claim 1, wherein the at least one processor is configured to specify the length of the time in accordance with an analysis target.

4. The information processing system according to claim 1, wherein the at least one processor is configured to specify a coding parameter set to be constant at the time from among a plurality of coding parameters of the second video image in accordance with the analysis target.

5. The information processing system according to claim 1, wherein the at least one processor is configured to specify, at the time, the coding parameter for an area of a specific part of a subject used for an analysis to be constant.

6. The information processing system according to claim 1, wherein the at least one processor is configured to specify at least one of the length of the time and a starting point of the time based on at least one of a measured value and a predicted value of a bandwidth available in a network through which the second video image is distributed.

7. The information processing system according to claim 1, wherein the image quality of the second video image includes an image quality based on at least one of a bit rate of coding, a frame rate of the coding, a quantization parameter of the coding, and an area of each layer in hierarchical coding.

8. An information processing method comprising:
processing for specifying a time when a change in an image quality of a second video image is set to be equal to or smaller than a threshold based on information about a first video image to be distributed; and
processing for transmitting information for setting a change in the image quality of the second video image to be equal to or smaller than the threshold at the specified time and causing the second video image to be distributed.

9. The information processing method according to claim 8, wherein, in the specifying processing, a length of the time is specified in accordance with an image quality of the first video image.

10. The information processing method according to claim 8, wherein, in the specifying processing, the length of the time is specified in accordance with an analysis target.

11. The information processing method according to claim 8, wherein, in the specifying processing, a coding parameter set to be constant at the time is specified from among a plurality of coding parameters of the second video image in accordance with the analysis target.

12. The information processing method according to claim 8, wherein, in the specifying processing, the coding parameter for an area of a specific part of a subject used for an analysis is specified to be constant.

13. The information processing method according to claim 8, wherein, in the specifying processing, at least one of the length of the time and a starting point of the time is specified based on at least one of a measured value and a predicted value of a bandwidth available in a network through which the second video image is distributed.

14. The information processing method according to claim 8, wherein the image quality of the second video image includes an image quality based on at least one of a bit rate of coding, a frame rate of the coding, a quantization parameter of the coding, and an area of each layer in hierarchical coding.

15. An information processing apparatus comprising:
at least one memory storing instructions, and
at least one processor configured to execute the instructions to;
specify a time when a change in an image quality of a second video image is set to be equal to or smaller than a threshold based on information about a first video image to be distributed; and
transmit information for setting a change in the image quality of the second video image to be equal to or smaller than the threshold at the specified time and causing the second video image to be distributed.

16. The information processing apparatus according to claim 15, wherein the at least one processor is configured to specify a length of the time in accordance with the image quality of the first video image.

17. The information processing apparatus according to claim 15, wherein the at least one processor is configured to specify the length of the time in accordance with an analysis target.

18. The information processing apparatus according to claim 15, wherein the control means determines a coding parameter set to be constant at the time from among a plurality of coding parameters of the second video image in accordance with the analysis target.

19. The information processing apparatus according to claim 15, wherein the at least one processor is configured to specify, at the time, the coding parameter for an area of a specific part of a subject used for an analysis to be constant.

20. The information processing apparatus according to claim 15, wherein the at least one processor is configured to specify at least one of the length of the time and a starting point of the time based on at least one of a measured value and a predicted value of a bandwidth available in a network through which the second video image is distributed.

21. (canceled)
